(19) United States
(12) Patent Application Publication
(10) Pub. No.: US 2004/0135437 A1
(43) Pub. Date: Jul. 15, 2004

(54) Apparatus for EMC-optimized activation of electrical loads

(76) Inventors: Thomas Mohr, Buehlertal (DE); Nikolas Haberl, Lauf (DE)

Correspondence Address: KENYON & KENYON, ONE BROADWAY, NEW YORK, NY, 10004, US

(21) Appl. No.: 10/717,292

(22) Filed: Nov. 18, 2003

(30) Foreign Application Priority Data
Dec. 30, 2002 (DE) 102 61 739.2

(51) Int. Cl. H02J 1/00; H02J 3/00

(52) U.S. Cl. 307/38

(57) ABSTRACT

A method for activating n electrical loads in a circuit assemblage, the activation being accomplished with pulse width modulated signals. Both an inductance L influencing electromagnetic compatibility and a capacitance C influencing the same, with which a current I_{L} flowing in a supply lead can be buffered, are provided. The n pulse width modulated signals are generated in time-offset fashion so that the effective value of a current I_{L} flowing in a supply lead to the N electrical loads is reduced.

### FIELD OF THE INVENTION

The present invention relates to an apparatus for EMC-optimized activation of electrical loads.

### BACKGROUND INFORMATION

Electromagnetic compatibility (EMC) is an electrical system's property of behaving neutrally in the vicinity of other systems. Applied to a motor vehicle, this means that the various electrical and electronic systems installed therein—e.g. the ignition system, electronic fuel injection system, ABS-ASR, airbag, car radio, mobile telephone, navigation system, and the like—must be functional in close physical proximity to one another, and must not impermissibly influence one another. The motor vehicle as a system must fit neutrally into its environment, i.e. it must not electrically influence other vehicles or disrupt the transmission of radio, television, and other wireless services. Conversely, the motor vehicle must remain completely functional in the presence of strong fields (e.g. in the vicinity of transmitters). Electrical systems for motor vehicles, and motor vehicles as a whole, must therefore be equipped so that they are electromagnetically compatible.

In order to control blower motors such as those used, for example, in automotive applications, high-frequency clock-pulse controllers may be used with which the blower motors can be controlled in low-loss and stepless fashion. EMC (electromagnetic compatibility) provisions are used in order to improve EMC, especially in terms of line-conducted emission. This is done by using inductances and capacitances that favorably influence EMC characteristics and that are positioned within an activation system for the blower motors between a voltage source and the power semiconductor components with which the blower motors are activated. Without an EMC-improving provision, a motor vehicle's electrical system would be subjected to a high current Iₘₐₓ. The inductances (coils) and capacitances (capacitors) used within the EMC provision result in double lowpass filtration of the current. The dimensioning of the inductance and capacitance substantially depends, in the long-wave and the short-wave region, on the maximum current Iₘₐₓ that is flowing and on the frequency f=1/t_{perid} at which it is clock-pulsed. At present, high-frequency clock-pulsed controllers may be clock-pulsed at frequencies greater than or equal to 20 kHz.

The inductance and capacitance of the EMC provision are dimensioned as a function of the maximum current Iₘₐₓ flowing in the electrical system of a motor vehicle.

The International Application WO 88/10367 refers to a method for activating electrical loads in which, when relatively large loads are switched, those loads are switched on and off in time-offset fashion in such a way that a current flowing in the context of the switching-on operation rises substantially continuously, and decreases again substantially continuously in the context of the switching-off operation.

The International Application WO 98/58445 refers to a method for activating at least two electrical loads. According to this method, at least two electrical loads are activated using a common circuit assemblage by pulse width modulated signals, a lead current that flows during an interpulse off-time of the pulse width modulated signal, and is dependent on an inductance of the electrical connecting lines, being absorbed by a buffer capacitance. The pulse width modulated signals are generated in temporally offset fashion. Upon superimposition of the pulse width modulated signals, simultaneous occurrence of an interpulse off-time for all pulse width modulated signals is avoided. The pulse width modulated signals are activated at a pulse duty factor of 50%, the pulse width modulated signals being generated with a temporal offset of half a period from one another.

### SUMMARY OF THE INVENTION

The approach proposed according to the exemplary embodiment and/or exemplary method of the present invention provides for an apparatus for activating at least two electrical drive systems that is optimized in terms of electromagnetic compatibility (EMC). The two electrical drive systems, which can be direct current (DC) motors, can be used (to name one application example) as blower motors for motor vehicle radiators. As a result of an activation of the power semiconductor elements activating the at least two electrical loads that is optimal in terms of electromagnetic compatibility, using pulse width modulated signals having a pulse duty factor of 40 or 60, preferably 50%, the maximum non-DC current Iₘₐₓ flowing in the motor vehicle's electrical system can be limited to Iₘₐₓ/2.

Since the maximum current flowing in the vehicle's electrical system can be halved by way of the approach proposed according to the exemplary embodiment and/or exemplary method of the present invention, and the maximum current value represents a criterion with regard to dimensioning of the inductance or capacitance utilized in the EMC provision, the aforementioned components utilized in the EMC provision can be of smaller dimensions, since only a fraction of their original inductance or capacitance is necessary. As a result of the proposed provision, the inductances (coils) and capacitances (capacitors) utilized for interference suppression, especially in the long-wave region, can be of considerably smaller dimensions.

If the power semiconductor components activating the at least two electrical drive systems are activated at a pulse duty factor of preferably 50%, the motor vehicle's electrical system sees a “true” direct current. At the other indicated pulse duty factors, i.e. at a pulse duty factor of 40% or one of 60%, the amplitude of the pulse current in the electrical system can be halved. In addition, the current flowing through electrolytic capacitors can be reduced to half the current as compared to simultaneous clock-pulsing of the power semiconductor components controlling the at least two electrical drive systems. The power semiconductor components used can be, for example, MOSFET transistors, bipolar transistors, or IGBT or IGCT transistors.

As a further possibility for activating the at least two electrical loads, a time-offset energization of the two blower motors at different pulse duty factors can be accomplished on the principle described above. This provides a use for the two electrical loads as fan motors for a double blower on the radiator of a motor vehicle, in which context one electrical drive system can be used as a fan for the vehicle radiator of the internal combustion engine, and the second electrical drive system can be used as a fan, for example, for the heat exchanger of a climate control system.

### BRIEF DESCRIPTION OF THE DRAWINGS

FIG. 1 shows an apparatus for activating at least two electrical loads using an EMC provision.

FIG. 2 shows the profile of the activation signal U_{Gate} activating two electrical loads, as well as the profile of a current flowing in the supply lead.

FIG. 3 shows an apparatus according to the present invention, optimized in terms of EMC characteristics, for activating two electrical loads.

FIG. 4 shows the activation signal profiles of activation signals U_{Gate1} and U_{Gate2}, and the current profile occurring in the supply lead, for a first pulse duty factor.

FIG. 5 shows signal profiles for first activation signal U_{Gate1} and second activation signal U_{Gate2}, and the resulting current profile within the supply lead, for an optimized pulse duty factor.

FIG. 6 shows the signal profiles of both activation signals U_{Gate1}, U_{Gate}2 for a further pulse duty factor, and the resulting lead current I_{L}.

FIG. 7 shows the profile of current I_{EFF} through an electrolytic capacitor, plotted for various pulse duty factors for a single output stage.

FIG. 8 shows the profile of effective electrolytic capacitor current I_{EFF} for a double output stage.

### DETAILED DESCRIPTION

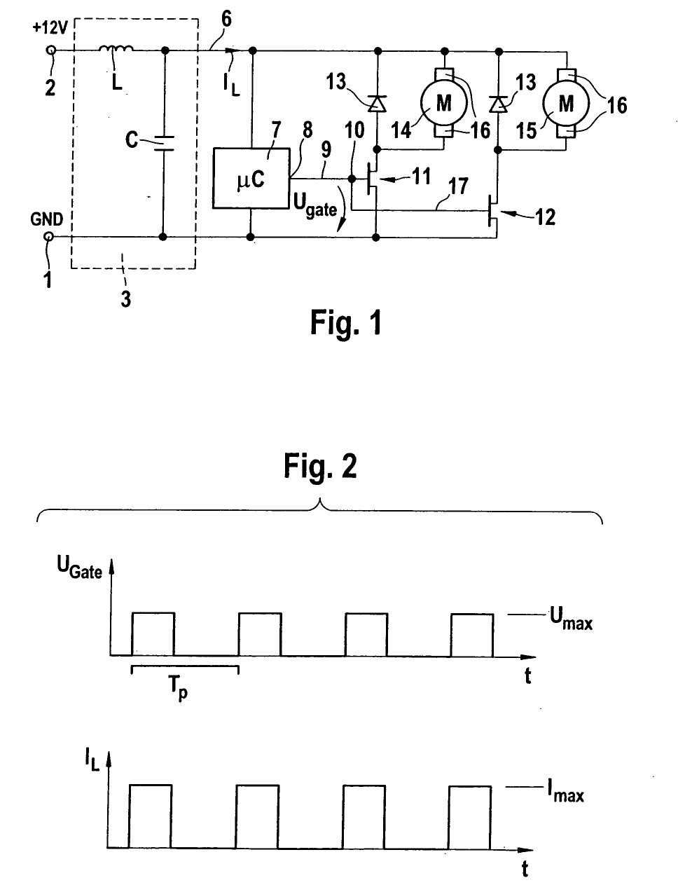

FIG. 1 shows an apparatus for activating at least two electrical loads by an EMC provision that contains an inductance and a capacitance.

The circuit assemblage depicted in FIG. 1 (and available) encompasses a ground connection 1 as well as a supply voltage terminal 2. Provided between connections 1 and 2 and a microcontroller 7 (μC) of the circuit assemblage is an EMC provision 3 that contains a inductance L and a capacitance C. A supply lead 6 extends between EMC provision 3 and the components of the circuit assemblage. The current flowing in supply lead 6 is labeled I_{L}. The circuit assemblage as depicted in FIG. 1 encompasses a microcontroller 7 (μC). Positioned on microcontroller 7 (μC) is an output 8 at which a first activation line 9 is provided. Associated with first activation line 9 for activating a first power semiconductor component 11 is a tapping point 10 to which a second activation line 17 is connected. A second power semiconductor component 12 is activated by a second activation line 17. The two power semiconductor components 11 and 12, which serve to activate a first electrical drive system 14 and a second electrical drive system 15, are activated simultaneously via microcontroller 7 and not independently of one another, i.e. in clock-pulsed fashion with shifted activation times, but rather are impinged upon simultaneously by one and the same signal generated by microcontroller 7 (μC). First electrical drive system 14 and second electrical drive system 15 each have a brush pair 16 associated with them. A respective freewheeling diode 13 is connected in parallel with first electrical drive system 14 and with second electrical system 15.

FIG. 2 further shows the profile of activation signal U_{Gate} activating the two electrical drive systems, as well as the profile of the current flowing in the supply lead.

Power semiconductor components 11 and 12 in the assemblage depicted in FIG. 1 are activated in parallel via first activation line 9, at a pulse duty factor having a pulse duration that corresponds to a fraction of a period Tₚ (maximum voltage Uₘₐₓ). During the interpulse off-time, i.e. the remaining portion of the time of period Tₚ, activation signal U_{Gate} has a value of 0. As a consequence there occurs in supply lead 6, during the pulse duration, a supply lead current I_{L} which assumes its maximum value Iₘₐₓ with simultaneous activation of both power semiconductor components 11 and 12. The electrical system of, for example, a motor vehicle would be impinged upon by this current if an EMC provision 3 in the form of an additional inductance L, or in the form of an additional capacitance C, were not provided.

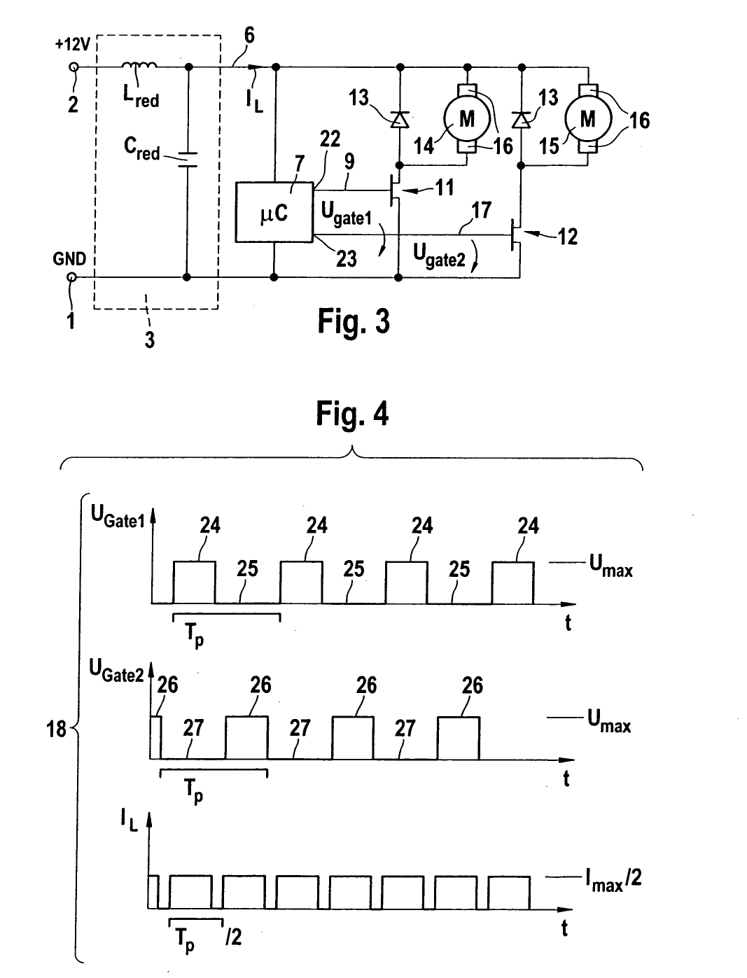

FIG. 3 shows an apparatus according to an exemplary embodiment of the present invention for activating two electrical loads that is optimized in terms of EMC characteristics.

The circuit assemblage depicted in FIG. 3 also encompasses a ground connection 1 as well as a supply voltage source 2 to which, for example, the 12-volt vehicle battery of a motor vehicle can be connected. EMC provision 3 encompasses an inductance L_{red} as well as a capacitance C_{red}. The inductances and capacitances positioned within EMC provision 3 represent reduced components (i.e. ones of smaller dimensions) which can be used in the exemplary apparatus proposed according to the present invention for activating two electrical drive systems 14 and 15. The current flowing in supply line 6 of the circuit assemblage shown in FIG. 3 is labeled I_{L}. The circuit assemblage as depicted in FIG. 3 encompasses a microcontroller 7 (μC) that encompasses a first output 22 as well as a second output 23. First activation line 9, with which first power semiconductor component 11 is activated, is connected to first output 22 of microcontroller 7 (μC). Second activation line 17, with which second power semiconductor component 12 is activated, is connected to the further second output 23 provided on the output side of microcontroller 7 (μC). As shown in FIG. 3, the activation signal transmitted via first activation line 9 is labeled U_{Gate1}, while the signal transmitted via second activation line 17 is labeled U_{Gate2}.

Analogous to that shown in FIG. 1, first electrical drive system 14, with which a freewheeling diode 13 is connected in parallel, is activated via first power semiconductor component 11, whereas second electrical drive system 15, with which a freewheeling diode 13 is likewise connected in parallel, is activated by using second power semiconductor component 12 activated via second activation line 17 with activation signal U_{Gate2}. With the activation apparatus depicted in FIG. 3 and configured according to the exemplary embodiment of the present invention, the two electrical drive systems 14, 15 can be activated in time-offset fashion, i.e. first electrical drive system 14 can be activated at the times during which second electrical drive system 15 is not needed, and vice versa. This is to provide a utilization for a double blower, in which a fan drive system for cooling the cooling water of an internal combustion engine can be implemented with one of electrical drive systems 14, 15, and the fan driven via the second electrical drive system 15 can cool the heat exchanger of, for example, the climate-control system of a motor vehicle. The first electrical drive system 14 and second electrical drive system 15, which may be embodied as direct current motors (DC drive systems), each have a brush pair 16 associated with them. This is only schematically indicated in FIG. 3. Although entirely different pulse duty factors for electrical drive systems 14, 15 may be set, a particular advantage may be achieved when the two pulse duty factors PDF with which the two power semiconductor components 11 and 12 can be independently activated are less than or equal to 100% in total, i.e. when PDF_{out,total}=PDF_{out,14}+PDF_{out,15} is less than 100%.

According to another exemplary embodiment (not depicted), the exemplary method proposed according to the present invention that optimizes EMC characteristics can also be used to activate n electrical loads, rather than the two electrical loads depicted in conjunction with FIG. 3. With appropriate modification of microcontroller 7 to have more than two outputs 22, 23, the exemplary embodiment of FIG. 3 can also be expanded for the activation of n electrical loads, as represented by drive systems 14 and 15. Instead of outputs 22, 23 associated in FIG. 3 with microcontroller 7, the latter encompasses n outputs, through which n respective activation lines lead to n semiconductor components with which n electrical loads are respectively activated. Each of these n activation lines would carry a respective activation signal U_{Gate,n} with which the n power semiconductor components are activated. Preceding microcontroller 7 in this embodiment (not depicted) of the exemplary method proposed according to the present invention, analogously with the that in FIG. 3, is a filter element 3 that influences electromagnetic compatibility (EMC) and contains an inductance L as well as a capacitance C. A freewheeling diode is connected in parallel with each of the n electrical loads, the number in a circuit assemblage corresponding to the number n of electrical loads contained in the circuit assemblage.

FIG. 4 further shows the activation signal profiles of activation signals U_{Gate1}, and U_{Gate2} as well as the current profile occurring in the supply lead of the circuit assemblage shown in FIG. 3.

Activation signal U_{Gate1} transmitted via first activation line 9 to first power semiconductor component 11 encompasses pulse durations 24 as well as interpulse off-times 25 that occur during a period Tₚ. FIG. 4 depicts the signal profiles for a first pulse duty factor 18 of, for example, 40%. Thus, pulse duration 24 accounts for approximately 40% of the duration of period Tₚ, i.e. the resulting interpulse off-time 25 is slightly longer than pulse duration 24 during which activation signal U_{Gate1} assumes its maximum value (i.e. Uₘₐₓ).

Activation signal U_{Gate2} transmitted via second activation signal 17 to second power semiconductor component 12 is offset in time with respect to period TP. The pulse duration of second activation signal U_{Gate2} is labeled with reference character 26, while the interpulse off-time of activation signal U_{Gate2} is labeled with reference character 27. The two activation signals U_{Gate1} and U_{Gate2} each attain maximum voltage values Uₘₐₓ during their pulse durations 24 and 26, respectively.

Lead current I_{L} occurring in supply lead 6, here plotted against half periods Tₚ/2, amounts to only half (i.e. Iₘₐₓ/2) of current Iₘₐₓ in a circuit assemblage without EMC provision 3. Inductance L and capacitance C act not on current I_{L}, but rather exclusively on the current that flows between supply voltage connection 2 and inductance L and powers the circuit assemblage.

Lead current I_{L} flowing in supply lead 6 at a first pulse duty factor 18 (40%) corresponds in magnitude to half the maximum current value Iₘₐₓ of FIG. 2 (i.e. Iₘₐₓ/2). Since supply lead current I_{L} flowing in supply lead 6 can be more than halved at first pulse duty factor 18, the inductances and capacitances provided in EMC provision 3 as in the circuit assemblage in FIG. 3 can be of smaller dimensions, i.e. can be physically smaller and designed for lesser requirements, i.e. a reduced inductance L_{red} and a reduced capacitance C_{red} can be used (cf. FIG. 3).

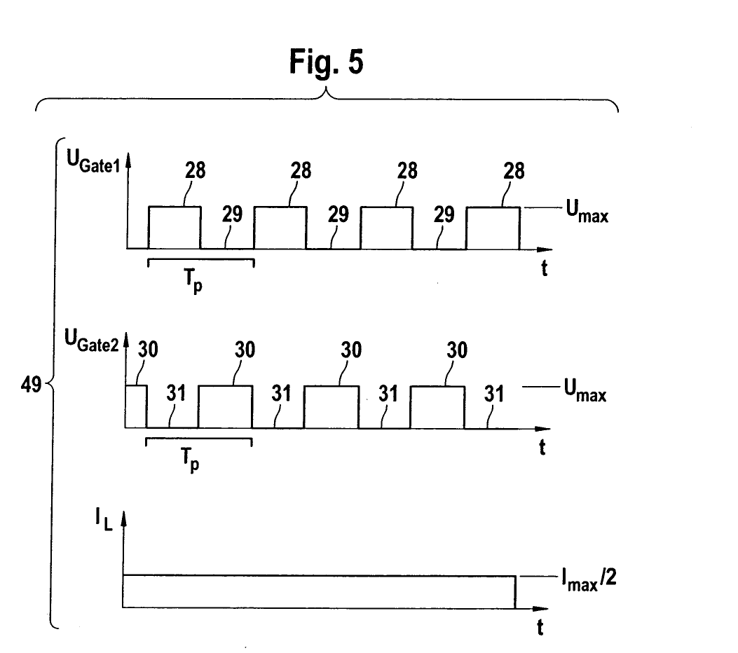

FIG. 5 shows the signal profiles of first activation signal U_{Gate1} and of second activation signal U_{Gate2} with which power semiconductor components 11 and 12, respectively, of the circuit assemblage shown in FIG. 3 can be activated, as well as the current profile within supply lead 6 resulting from activation signals U_{Gate1} and U_{Gate2}.

At an optimized pulse duty factor 19 (50%), pulse durations 28 as well as interpulse off-times 29 (identical in duration to pulse duration 28) are present in alternating sequence during one complete period Tₚ in first activation line 9. At an offset in time therefrom, pulse durations 30 and interpulse off-times 31 are present over one entire period Tₚ in alternating sequence on second activation line 17 for activating second semiconductor component 12. A feature “common” to activation signals U_{Gate1} and U_{Gate2} on first activation line 9 and second activation line 17 is that maximum voltage Uₘₐₓ is reached during pulse durations 28 and 30 in each case.

Current profile I_{L} in supply lead 6 resulting from the activation profiles of activation signals U_{Gate1} and U_{Gate2} corresponds to a true direct current that corresponds in terms of magnitude to half the maximum current Iₘₐₓ as in FIG. 2. At an optimized pulse duty factor 19 with which the two power semiconductor components 11 and 12 are activated via the respective activation lines 9 and 17, the electrical system of a motor vehicle sees, for example, a true direct current. The current flowing through electrolytic capacitors is also reduced to half the current value as compared to simultaneous clock-pulsing of the two power semiconductor components 11 and 12 as shown in the circuit assemblage of FIG. 1.

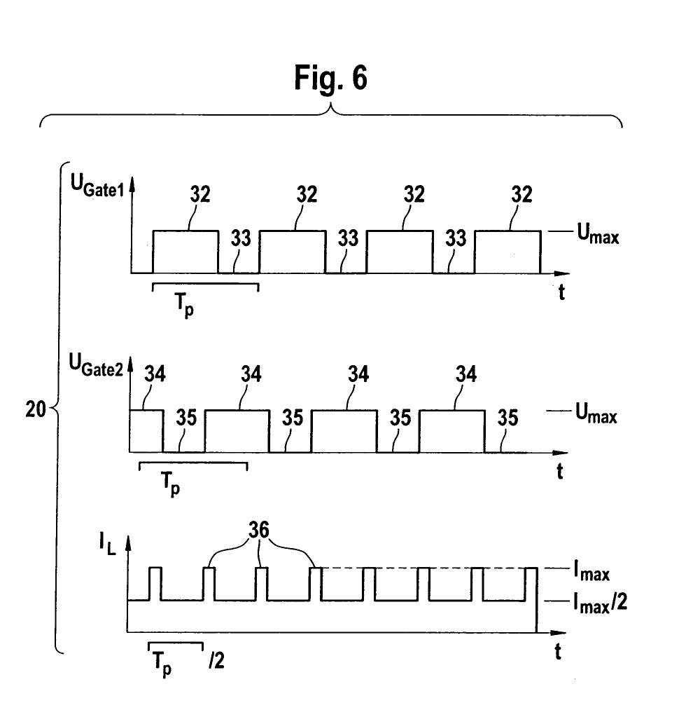

FIG. 6 shows the signal profiles of two activation signals U_{Gate1} and U_{Gate2} at a further, third pulse duty factor, as well as the resulting lead current I_{L}.

When a pulse duty factor 20 (60%) is set for activation of the two power semiconductor components 11, 12 of the apparatus for activating at least two electrical drive systems 14, 15 as shown in FIG. 3, over one complete period Tₚ the maximum voltage Uₘₐₓ in first activation line 9 is present, in terms of first activation signal U_{Gate1}, during pulse duration 32. Pulse duration 32 is followed in the signal profile by an interpulse off-time 33 that, because third pulse duty factor 20 is set, is shorter than the duration of pulse 32.

The further, second activation signal U_{Gate2} proceeds at an offset from the profile of first activation signal U_{Gate1}. Its pulse duration 34, similarly to the signal profile of first activation signal U_{Gate1} is longer over period Tₚ than interpulse off-times located between the individual pulse durations 34.

The result of activating the two power semiconductor elements 11 and 12 with activation signals U_{Gate1} and U_{Gate2}, respectively, via first activation line 9 and second activation line 17 is to create in supply lead 6 a current profile I_{L} that is characterized by individual current/voltage peaks 36. An optimized electrical system current Iₘₐₓ/2 occurs during each half period Tₚ/2, the current level in supply lead 6 assuming a maximum current value Imax at the beginning of each half period Tₚ/2.

With the exemplary apparatus according to the present invention, the two electrical drive systems 14, 15 may be generated at different pulse duty factors within the range between 10 and 90% using the same principle, i.e. that of time-offset energization. This provides for utilization of a double blower containing two mutually independent electrical drive systems, in which context the first electrical drive system 14 can be used as a fan drive system for cooling the coolant water of an internal combustion engine, and second electrical drive system 15 can be used as a fan drive system for the heat exchanger of a climate-control system.

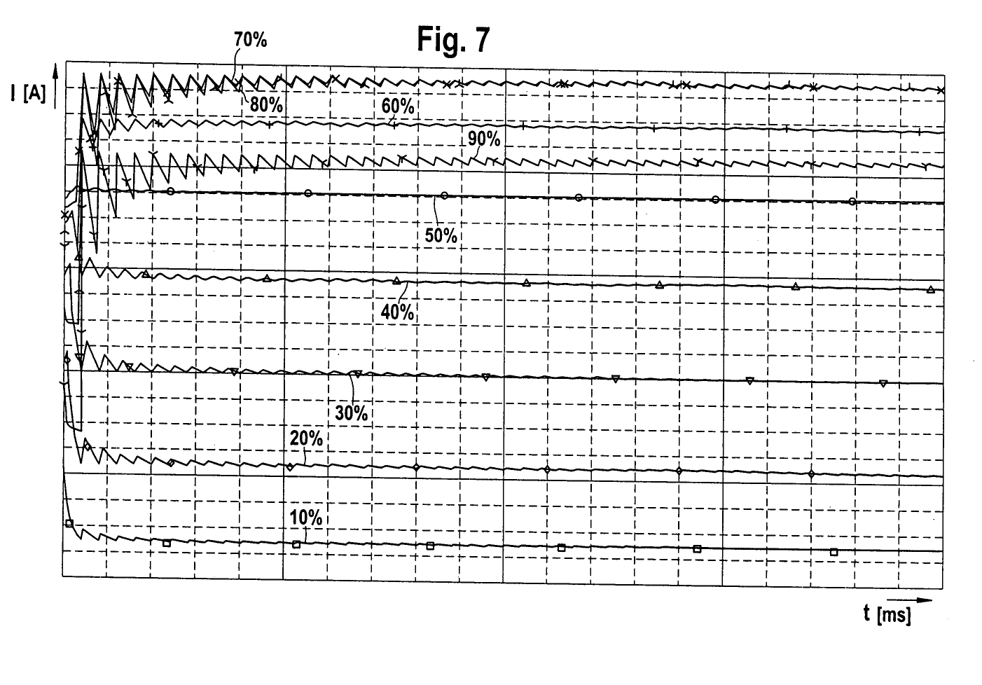

FIG. 7 illustrates the profile of current I through an electrolytic capacitor.

The currents flowing through the electrolytic capacitors for pulse duty factors of 10% to 90% are respectively plotted against the time axis. For activation of a single output stage, as embodied e.g. by connecting in parallel two output stages 14, 15 as in FIG. 1, the result at a pulse duty factor of 50% is a current I (electrolytic capacitor current) of 7.5 A. At pulse duty factors of 70% and 80% for activation of a single output stage, as in FIG. 1 as a parallel connection of two output stages, currents I of between 9 A and 9.5 A are obtained. For pulse duty factors selected at correspondingly low levels (10%), a current of, for example, between 0.5 and 1 A occurs in the electrolytic capacitor, and has reached its steady state after decaying for a few ms. At a pulse duty factor of 20%, the current occurring in supply lead 6 is approximately 2.2 A, an increase in the pulse duty factor being associated with an increase in the settling time of the currents in supply lead 6.

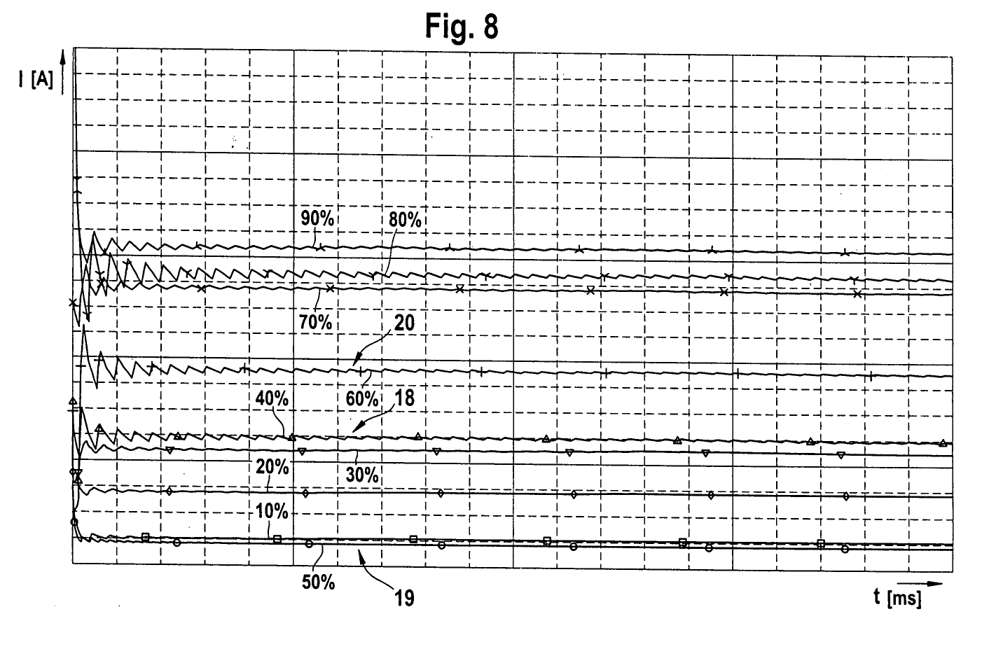

FIG. 8 shows the profile of the electrolytic capacitor current for a double output stage in the form of two independent output stages (in accordance with the circuit assemblage of FIG. 3).

When two power semiconductor components 11 and 12 are activated via a double output stage, e.g. of two independent output stages, the current I shown in FIG. 8 occurs in electrolytic capacitor 3. For an optimum pulse duty factor 19 (50%), the current flowing in the supply lead assumes a value below 0.5 A. For a first pulse duty factor 18 (40%; cf. depiction in FIG. 4), an electrolytic capacitor current of approximately 2.5 A as shown in FIG. 8 occurs, except for a transient phase lasting a few ms. For a further, second pulse duty factor 20 (cf. depiction in FIG. 6), the result is an effective electrolytic capacitor current I_{EFF} of between 3.5 and 4 A. The current flowing from supply voltage terminal 2 to the EMC provision is filtered by the LC filter. When the two power semiconductor components 11 and 12 for the two electrical loads 14, 15 (DC actuating drive systems) are activated at a pulse duty factor 18 depicted in FIG. 4 or at the optimized pulse duty factor 19 depicted in FIG. 5, the frequency of current I_{L} affecting the electrical system (i.e. in this case supply lead 6) is halved. Because the frequency of the ripple current is halved, the service life of capacitors, as represented e.g. by electrolytic capacitors, can be considerably increased. By halving the frequency of the ripple current of the optimized electrical system current Iₘₐₓ/2 (identical to I_{L}), the current level applied to capacitance C_{red} may be decreased.

The percentage values from 10% to 90% shown in FIGS. 7 and 8, plotted in each case in 10% steps, represent the various pulse duty factors that are derivable from the pulse width modulated signals U_{Gate} as shown in FIG. 2, and U_{Gate1}, U_{Gate2} as shown in FIGS. 4, 5, and 6.

The reference numbers are as follows:

1 Ground connection

2 Supply voltage connection

3 Emc provision

4 L=inductance

5 C=capacitance

6 Supply lead

7 Microcontroller (μC)

8 Output

9 First activation line

10 Tapping point

11 First power semiconductor component

12 Second power semiconductor component

13 Freewheeling diode

14 First electrical drive system

15 Second electrical drive system

16 Brush pair

17 Second activation line

U_{Gate} Activation signal

I_{L} Lead current

Uₘₐₓ Maximum voltage

Tₚ Period

U_{Gate1} Activation signal of first μC output

U_{Gate2} Activation signal of second μC output

Tₚ/2 Half period

18 First pulse duty factor

19 Optimum pulse duty factor

20 Third pulse duty factor

Iₘₐₓ/2 Optimized electrical system current

L_{red} Reduced inductance

C_{red} Reduced capacitance

22 First output of microcontroller μC

23 Second output of microcontroller μC

24 Pulse duration, first PDF, U_{Gate1}

25 Interpulse off-time, first PDF, U_{Gate1}

26 Pulse duration, first PDF, U_{Gate2}

27 Interpulse off-time, first PDF, U_{Gate2}

28 Pulse duration, PDFₒₚₜ, U_{Gate1}

29 Interpulse off-time, PDFₒₚₜ, U_{Gate1}

30 Pulse duration, PDFₒₚₜ, U_{Gate2}

31 Interpulse off-time, PDFₒₚₜ, U_{Gate2}

32 Pulse duration, third PDF, U_{Gate1}

33 Interpulse off-time, third PDF, U_{Gate1}

34 Pulse duration, third PDF, U_{Gate2}

35 Interpulse off-time, third PDF, U_{Gate2}

36 Voltage peak (Iₘₐₓ).

What is claimed is:

1. A method for activating a number n of electrical loads in a circuit assemblage, n being at least 2, the method comprising:
activating the n electrical loads by n pulse width modulated signals, wherein for the activating of the n electrical loads, the n pulse width modulated signals are generated in a time-offset so that an effective value of a direct current flowing in a supply lead to the n electrical loads is reduced.

2. The method of claim 1, wherein a filter for influencing electromagnetic compatibility is placed upstream from the n electrical loads.

3. The method of claim 1, wherein the time offset between the n pulse width modulated signals equals an nth part of a period of the pulse width modulated signals.

4. The method of claim 1, wherein the n electrical loads are activated with the n pulse width modulated signals at a pulse duty factor of 1/N.

5. The method of claim 1, wherein at a pulse duty factor of 1/N, the direct current, which is reduced by half as compared to an amplitude of a maximally permissible current, is generated in the supply lead to an electrical system of a motor vehicle.

6. The method of claim 1, wherein the n electrical loads are activated by power semiconductor components respectively associated with them, each of which has associated with it a separate activation line for transmission of the pulse width modulated signals.

7. An apparatus for activating n electrical loads, comprising:
a filter to influence electromagnetic compatibility, the filter including an inductance arrangement and a capacitance arrangement; and
a microcontroller to activate the n electrical loads and to generate activation signals, for providing time-offset energization of n power semiconductor components, wherein the microcontroller includes a first output and a second output to which a first activation line and a second activation line are connected for activating the n power semiconductor components of the n electrical loads;
wherein the apparatus activates the n electrical loads by n pulse width modulated signals, wherein for the activating of the n electrical loads, the n pulse width modulated signals are generated in a time-offset so that an effective value of a direct current flowing in a supply lead to the n electrical loads is reduced.

8. The apparatus of claim 7, wherein the n power semiconductor components include at least one of MOSFET transistors, bipolar transistors, IGBT transistors and IGCT transistors.

9. The apparatus of claim 7, wherein a first electrical load and a second electrical load represents one of a double blower and a tandem blower, one of the electrical loads being associated with a radiator of an internal combustion engine and another of the electrical loads being associated with a heat exchanger of a vehicle climate control system of a motor vehicle.
